(19) United States
(12) Patent Application Publication
(10) Pub. No.: US 2009/0029325 A1
(43) Pub. Date: Jan. 29, 2009

(54) VIRTUAL LOCOMOTIVE SIMULATION SYSTEM AND METHOD

(75) Inventor: Michael Hetherington, Williamston, MI (US)

Correspondence Address: GIFFORD, KRASS, SPRINKLE,ANDERSON & CITKOWSKI, P.C, PO BOX 7021, TROY, MI, 48007-7021, US

(73) Assignee: P.I. Engineering, Inc., Williamston, MI (US)

(21) Appl. No.: 12/122,338

(22) Filed: May 16, 2008

Related U.S. Application Data
(60) Provisional application No. 60/938,867, filed on May 18, 2007.

(51) Int. Cl. G09B 9/04

(52) U.S. Cl. 434/29

(57) ABSTRACT

A complete hardware and software railroad training system gives the trainee a hands-on operators experience in a safe and productive classroom environment. The system and method combines a complete virtual simulation of a yard and the associated equipment with a cost-effective Operator Control Unit (OCU) to fully address Remote Control Operation (RCO), including equipment handing, yard familiarization, rules and safety training. A simulated locomotive training system according to the invention comprises a computer system generating a display of an avatar in a simulated railroad environment including a virtual locomotive and associated equipment. The OCU, a hand-held unit in communication with the computer system, includes one or more video-game or “game-pad” type controls, enabling a user to manipulate the avatar in the simulated railroad environment. The controls may be joystick controllers, allowing a user to navigate, view and select objects and actions in the simulated railroad environment without the user's hands having to leave the OCU. Right and left controls, each operated by one finger on each of a user's hands, respectively direct the movement of the avatar in the simulated railroad environment and change the view of the avatar in the simulated railroad environment.

### REFERENCE TO RELATED APPLICATION

This application claims priority from U.S. Provisional Patent Ser. No. 60/938,867, filed May 18, 2007, the entire content of which is incorporated herein by reference.

### FIELD OF THE INVENTION

This invention relates generally to the training of railroad personnel and, in particular, to a system and method that combines a complete virtual simulation of a yard and the associated equipment with a cost-effective Operator Control Unit (OCU) that fully addresses Remote Control Operation (RCO)₇ including equipment handing, yard familiarization, rules and safety training.

### BACKGROUND OF THE INVENTION

Training railroad personnel has traditionally been an apprentice-based system. While this tradition has served the railroads well for the past 150 years, today's technology, economics and safety considerations require considerable supplemental training. Remote Control Operation (RCO) requires additional skills and training in an already full training schedule for the new conductor.

### SUMMARY OF THE INVENTION

This invention provides a complete hardware and software railroad training system that gives the trainee a hands-on operators experience in a safe and productive classroom environment. The system and method combines a complete virtual simulation of a yard and the associated equipment with a cost-effective Operator Control Unit (OCU). The combination fully addresses Remote Control Operation (RCO), including equipment handing, yard familiarization, rules and safety training.

A simulated locomotive training system according to the invention comprises a computer system generating a display of an avatar in a simulated railroad environment including a virtual locomotive and associated equipment. The OCU, a hand-held unit in communication with the computer system, includes one or more video-game or “game-pad” type controls, enabling a user to manipulate the avatar in the simulated railroad environment.

In the preferred embodiment, the controls are joystick controllers, allowing a user to navigate, view and select objects and actions in the simulated railroad environment without the user's hands having to leave the OCU. The preferred embodiment includes right and left controls, each operated by one finger on each of a user's hands. One of the controls directs the movement of the avatar in the simulated railroad environment; the other control changes the view of the avatar in the simulated railroad environment.

The controls may also be pressed to change what is currently being viewed in the simulated environment or to provide on-screen menus associated with various control various aspects of the simulation. The controlled aspects may include one or more of the following: uncoupling, handbrake on/off, changing switch direction, bringing up a task list, acknowledging dialogue boxes, pausing the simulation or ending the simulation.

### BRIEF DESCRIPTION OF THE DRAWINGS

FIG. 1 is a display showing animated switch points and interactive lesson boxes; and

FIG. 2 is an oblique representation of an operator control unit according to the invention.

### DETAILED DESCRIPTION OF THE INVENTION

Today's railway conductor has many responsibilities, from reading work orders and switch and track lists, to deciding what cuts to take, and how many cars can be kicked based on the current restrictions and requirements of the commodity. Add to this the actual operation of the locomotive through radio controlled OCU then add the current safety and hazardous material requirements, and we have a tremendous amount of learning for any newly hired employee. This invention is directed to simulation training that helps accelerate this critical learning process.

Remote Control Operations (RCO) requires extensive training. The TrainMaster simulation platform from PI Engineering (101 Innovation Parkway, Williamston, Mich. 48895-1663) facilitates the creation of training and familiarization scenarios for operating heavy equipment utilizing the latest video game engine technology. The game-based engine provides a realistic 3D world depiction both visually and audibly, drawing the student into the training experience. More details about the TrainMaster simulation platform can be found at www.trainmaster.com, the entire content of which is incorporated herein by reference.

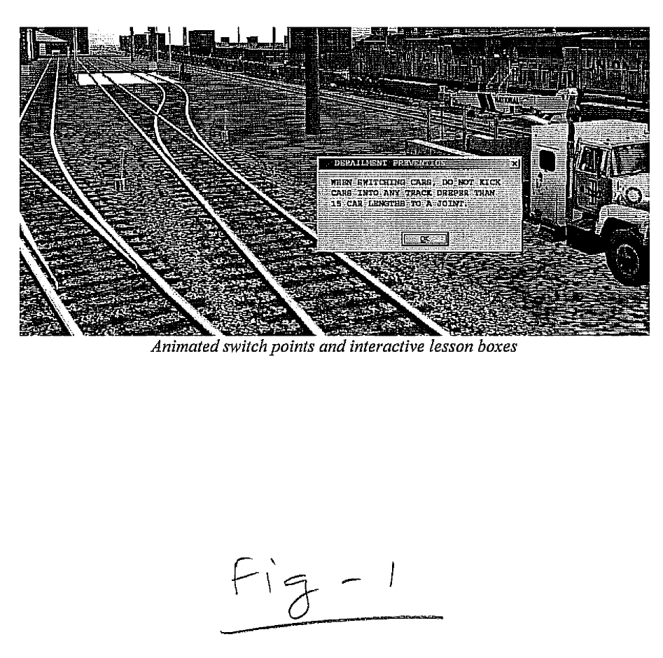

TrainMaster has also developed effective classroom lessons for this specialized training. TrainMaster is currently the only simulator system that addresses the hardware, logistics and safety of the Remote Operator's job. The program teaches the set-up, use and safety of this equipment in the classroom so as not to tie up equipment in the yard. This simulation system gives the trainee real “box” time under full supervision of an instructor without the cost or danger associated with on-the-job training. The enhanced computer graphics and animations of the TrainMaster platform provide all important details, including the movement and positions of the actual switch points as well as the targets, as shown in FIG. 1. Derails and blue flags are also included as part of this training system.

This invention extends and builds upon the TrainMaster simulation platform by providing trainees with an Operator Control Unit (OCU) which, in the preferred embodiment has all the functional controls required to simulate operating a locomotive by remote control within the TrainMaster Professional software developed by PI Engineering, Inc. The TrainMaster Professional software is a 3D simulation environment to train students to operate equipment in a realistic and safe environment. While the OCU has a number of unique features that are specific and integral to its use with the TrainMaster Professional software, the OCU may take advantage of other software environments if developed for compatibility.

According to the invention, a trainee operates a virtual locomotive using their own OCU and encounters various training situations, normal or abnormal. Important simulation events, such as equipment speed, safety or rules violations, as well as other student behavior, are monitored and tied directly to pop-up windows with rules, warnings, hints, and commendations. The instantaneous feedback allows immediate attention to both safe and unsafe behavior, reinforcing the former and discouraging the latter. The basic training of RCO is very similar for all railroads, but each has its own unique details and specific locations. TrainMaster is designed to address the common problems with a fully customized solution for exact training needs.

A large database of remote and standard railroad equipment, coupled with specially developed tools, expedites the ability to produce yards, industry and main line track from track charts and readily available satellite and topographic information. Various features of the OCU are detailed as follows.

USB Connectivity. While the OCU may be equipped with radio transmission or reception capabilities as real-world OCUs have, in the preferred embodiment a wired connection is provided to the computer running the simulation software. All OCU control inputs by the user are sent to the software via a USB cable. Similarly, any feedback for display on the OCU's integrated display is sent via a USB cable. The USB cable is not a standard USB cable. It is a combination cable that also incorporates wiring for stereo headphones which are worn by the user during the simulation to provide sound cues.

Programmability. The OCU is not modeled on any specific existing remote control unit. Instead it is based on a generic representation. The firmware which provides the internal logic for the unit is readily programmable via the USB cable mentioned above.

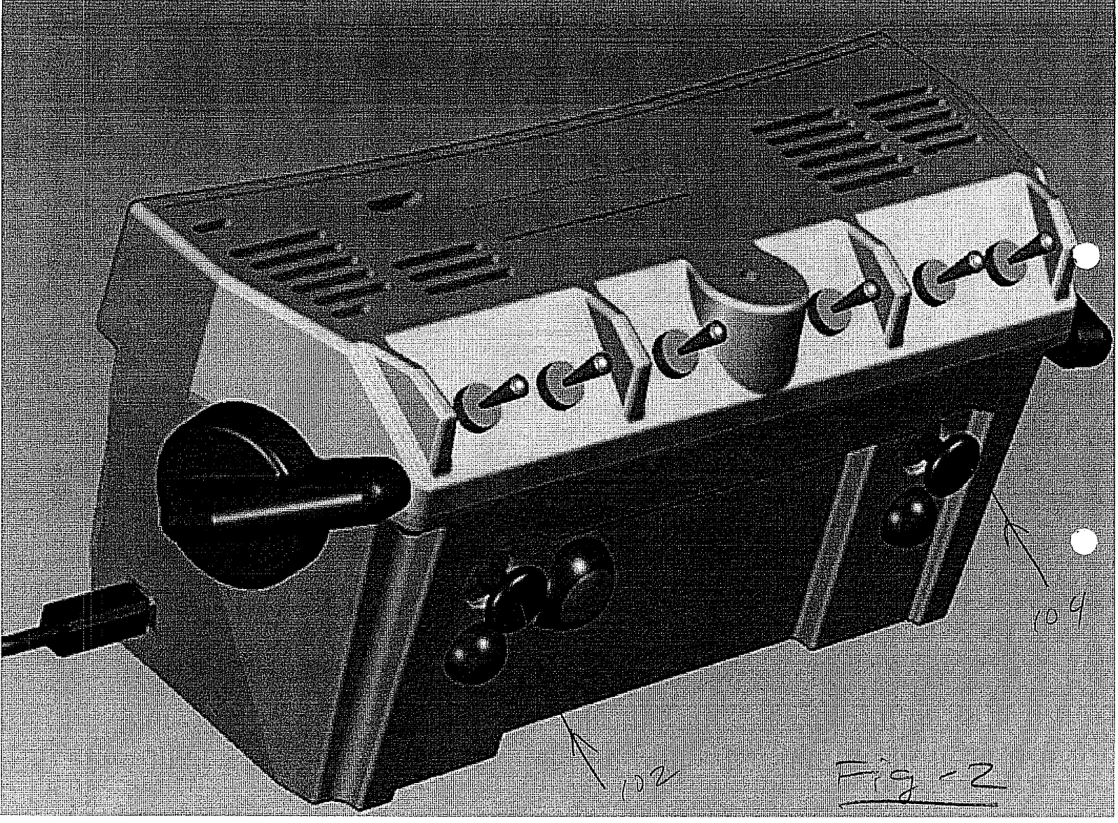

Joystick Navigation. An important distinction between the OCU and real-world controllers is the incorporation of two high-quality x-y “game-pad” type controllers, preferably joysticks (See FIG. 2). These joystick controllers are unique and form an integral part of the overall training solution. The joysticks 102, 104 are positioned so they lie comfortably under the left and right forefingers while addressing the OCU with the hands in the normal position of having the unit slung in front and at waist height.

Functionally, the joystick controllers allow the user to navigate, view and select objects/actions in the 3D simulation world without the user's hands having to leave the OCU hardware. The right joystick controls horizontal movement of the user's avatar in the 3D simulation world. The perspective of the user's avatar in the 3D simulation is first person, so the view and position changes with joystick movement directly in an intuitive fashion. The real world equivalent to using the night joystick is to control the avatar's “legs”.

The left joystick controls the user's avatar's view without changing the location within the 3D simulation. The 3D view changes with joystick movement directly in an intuitive fashion. The real world equivalent to using the left joystick is to control the avatar's “head”.

In the preferred embodiment, both joysticks have built-in buttons which operate by depressing the respective joystick. Combinations of joystick button presses, joystick position, and what is currently being viewed in the 3D simulation world and an on-screen menu system are used to control other aspects of the simulation. These include, but are not limited to: uncoupling, handbrake on/off, changing switch direction, bringing up a task list, acknowledging dialogue boxes, pausing the simulation or ending the simulation.

I claim:

1. A simulated locomotive training system, comprising:
a computer system generating a display of an avatar in a simulated railroad environment including a virtual locomotive and associated equipment; and
a hand-held operator control unit (OCU) in communication with the computer system, the OCU including one or more video-game type controls enabling a user to manipulate the avatar in the simulated railroad environment.

2. The simulated locomotive training system of claim 1, wherein the controls are joystick controllers.

3. The simulated locomotive training system of claim 1, wherein the controls allow a user to navigate, view and select objects and actions in the simulated railroad environment without the user's hands having to leave the OCU.

4. The simulated locomotive training system of claim 3, including right and left controls, each operated by one finger on each of a user's hands.

5. The simulated locomotive training system of claim 1, wherein one of the controls direct the movement of the avatar in the simulated railroad environment.

6. The simulated locomotive training system of claim 1, wherein one of the controls changes the view of the avatar in the simulated railroad environment.

7. The simulated locomotive training system of claim 1, wherein the controls may also be pressed to change what is currently being viewed in the simulated environment or to provide on-screen menus associated with various control various aspects of the simulation.

8. The simulated locomotive training system of claim 7, wherein the controlled aspects include one or more of the following: uncoupling, handbrake on/off, changing switch ending the simulation.

9. The simulated locomotive training system of claim 7, wherein the simulation is three-dimensional.
